(19) United States
(12) Patent Application Publication
(10) Pub. No.: US 2008/0063550 A1
(43) Pub. Date: Mar. 13, 2008

(54) Piston type compressor

(76) Inventors: Masaki Inoue, Kariya-shi (JP); Tetsuhiko Fukanuma, Kariya-shi (JP); Naoya Yokomachi, Kariya-shi (JP); Fuminobu Enokijima, Kariya-shi (JP); Shun Sumikawa, Kariya-shi (JP)

Correspondence Address: MORGAN & FINNEGAN, L.L.P., 3 World Financial Center, New York, NY, 10281-2101, US

(21) Appl. No.: 11/897,573

(22) Filed: Aug. 30, 2007

(30) Foreign Application Priority Data
Sep. 7, 2006 (JP) P2006-243070

(51) Int. Cl. F04B 27/08; F16J 15/02

(52) U.S. Cl. 417/521; 277/637

(57) ABSTRACT

A piston type compressor comprises a cylinder block having a plurality of cylinder bores, a plurality of pistons disposed in the respective cylinder bores for defining compression chambers in the respective cylinder bores, a housing for defining a suction-pressure region and a discharge-pressure region therein, a valve-port assembly provided between the cylinder block and the housing, and a seal member provided between the cylinder block and the housing. The seal member has a first seal portion for preventing the refrigerant from leaking out of the compressor and a second seal portion for preventing the refrigerant from leaking between adjacent refrigerant passages. Each of the first and second seal portions has a bead. The bead of the second seal portion has a height which is smaller than that of the first seal portion.

### BACKGROUND OF THE INVENTION

The present invention relates to a piston type compressor having a seal member which is interposed between a cylinder block and a rear housing of the compressor.

In a refrigeration cycle which uses carbon dioxide as refrigerant, the refrigerant circulates under a high pressure. A compressor used in such a refrigeration cycle needs to be made airtight enough to prevent refrigerant gas from leaking out thereof. For this purpose, a seal member having a bead, such as gasket and packing, is provided at a joint between the housing components of the compressor, for example, the joint between a cylinder block and a rear housing of the compressor, and the housing components are fastened together by a fastening member (cf. Japanese Patent Application Publication No. 2005-344625).

FIG. 5A shows the joint between the cylinder block 61 and the rear housing 62 of the compressor 60 which is disclosed in the above publication. As shown in FIG. 5A, the cylinder block 61 has formed therein a cylinder bore 63 receiving therein a reciprocable piston 65, thereby defining a compression chamber 64 for the refrigerant gas to be compressed. A suction chamber 66 and a discharge chamber 67 are defined in the rear housing 62. The suction chamber 66 is connected to the compression chamber 64 through a suction passage 68, and the discharge chamber 67 is connected to the compression chamber 64 through a discharge chamber 68. A gasket 70, a suction valve plate 71, a valve plate 72, a discharge valve plate 73, and a gasket 74 are interposed between the cylinder block 61 and the rear housing 62. A front housing (not shown), the cylinder block 61, the gaskets 70 and 74, the suction valve plate 71, the valve plate 72, the discharge valve plate 73, and the rear housing 62 are fastened together by bolts 75 by a predetermined force. The gaskets 70 and 74, the suction valve plate 71, the valve plate 72, the discharge valve plate 73, and a retainer 76 are fastened together by a bolt 77.

FIG. 5B shows the gasket 70 which is interposed between the cylinder block 61 and the rear housing 62. The gaskets 70 and 74 have substantially the same structure (are of substantially the same structure). In the following description, therefore, the gasket 70 will be mainly described and the description about the gasket 74 will be simplified or omitted. The gasket 70 includes a base plate 78 made of a metal having on both surfaces thereof rubber coatings 79. The gasket 70 has beads 80 through 82 which are formed at predetermined positions of the gasket 70. The bead 80 is formed so as to surround a hole 80a which is formed through the gasket 70 at its center for inserting the bolt 77 therethrough. The bead 81 is formed so as to surround a hole 81a which connects the compression chamber 64 to the suction passage 68 and the discharge passage 69. The bead 82 is formed adjacent to the outer periphery of the gasket 70 so as to surround a hole 80a which is formed in the gasket 70 for inserting each of the bolts 75 therethrough. In the above publication, where the heights of the beads 80 through 82 are denoted by symbols h1, h2 and h3, respectively, the beads 80 through 82 are formed so as to satisfy the following relation.

h1>h2>h3

### In other words, the beads 80 through 82 of the gasket 70 of the above publication have the heights which increase from the outer periphery (the bolt 75 side) toward the center of the compressor 60.

The bolts 75 are fastened by such a force that the gaskets 70 and 74 are pressed against the cylinder housing 61 and the rear housing 62, respectively, by the desired contact pressure. In the compressor 60, the refrigerant gas in the suction chamber 66 is drawn into the compression chamber 64 during the suction stroke when the piston 65 moves from its top dead center toward its bottom dead center. On the other hand, the drawn refrigerant gas is compressed to a predetermined pressure and discharged into the discharge chamber 67 during the compression and discharge stroke when the piston 65 moves from its bottom dead center toward its top dead center. Thus, during the suction and discharge strokes in operation of the compressor, the working pressures among the compression chambers 64, the suction chamber 66 and the discharge chamber 67 are varied. Due to the pressure variation, the valve plate 72 between the cylinder block 61 and the rear housing 62 is bent, thus the contact pressure of the gaskets 70 and 74 being changed. As the contact pressure of the gaskets 70 and 74 is changed in operation of the compressor 60, the beads 80 through 82 undergo repeated and alternate deformation by being pressed against the cylinder block 61 and the rear housing 62 and restoration to their original shape, with the result that the gaskets 70 and 74 may be cracked or damaged otherwise due to the repeated deformation and restoration of the gaskets 70 and 74. The beads which are located adjacent to a refrigerant passage (e.g. the compression chamber, the suction chamber, the discharge chamber and the like) in the compressor 60 are more susceptible to the change of the contact pressure. If the height of the bead 81 adjacent to the refrigerant passage is set large as in the above publication, the bead 81 is deformed considerably. As a result, the gasket is more susceptible to damage.

The present invention, which has been made in view of the above-described drawbacks of the background art, is directed to a compressor which reduces the deformation of a bead of a seal member which occurs when the contact pressure of the seal member is varied due to a change of pressure of the compressor, thereby to prevent damage of the seal member.

### SUMMARY OF THE INVENTION

An aspect in accordance with the present invention provides a piston type compressor comprising a cylinder block, a plurality of pistons, a housing, a valve-port assembly, and a seal member. The cylinder block has a plurality of cylinder bores. The plurality of pistons are disposed in the respective cylinder bores for defining compression chambers in the respective cylinder bores. The housing defines a suction-pressure region and a discharge-pressure region therein. The valve-port assembly is provided between the cylinder block and the housing. The valve-port assembly has suction ports which connects the suction-pressure region to the respective compression chambers and discharge ports which connects the respective compression chambers to the discharge-pressure region, thereby refrigerant passages being provided by the respective compression chambers, the suction-pressure region, the discharge-pressure region, the respective suction ports, and the respective discharge ports. Refrigerant is drawn from the suction-pressure region into the compression chambers through the respective suction ports and discharged from the compression chambers into the discharge-pressure region through the respective discharge ports after compression. The seal member is provided between the cylinder block and the housing. The valve-port assembly and the seal member are fastened together by a fastening member. The seal member has a first seal portion for preventing the refrigerant from leaking out of the compressor and a second seal portion for preventing the refrigerant from leaking between the adjacent refrigerant passages. Each of the first and second seal portions has a bead. The bead of the second seal portion has a height which is smaller than that of the first seal portion.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a longitudinal cross-sectional view of a piston type compressor of a preferred embodiment according to the present invention;

FIG. 2 is a partially enlarged cross-sectional view of the piston type compressor of the preferred embodiment;

FIG. 3A is a front view of a gasket of the preferred embodiment which is to be in press contact with a cylinder block;

FIG. 3B is a cross-sectional view that is taken along the line A-A in FIG. 3A;

FIG. 4A is a front view of a gasket of the preferred embodiment which is to be in press contact with a rear housing;

FIG. 4B is a cross-sectional view that is taken along the line B-B in FIG. 4A;

FIG. 5A is a partially enlarged cross-sectional view of a piston type compressor of the background art; and

FIG. 5B is a cross-sectional view of a gasket of the background art.

### DETAILED DESCRIPTION OF THE PREFERRED EMBODIMENTS

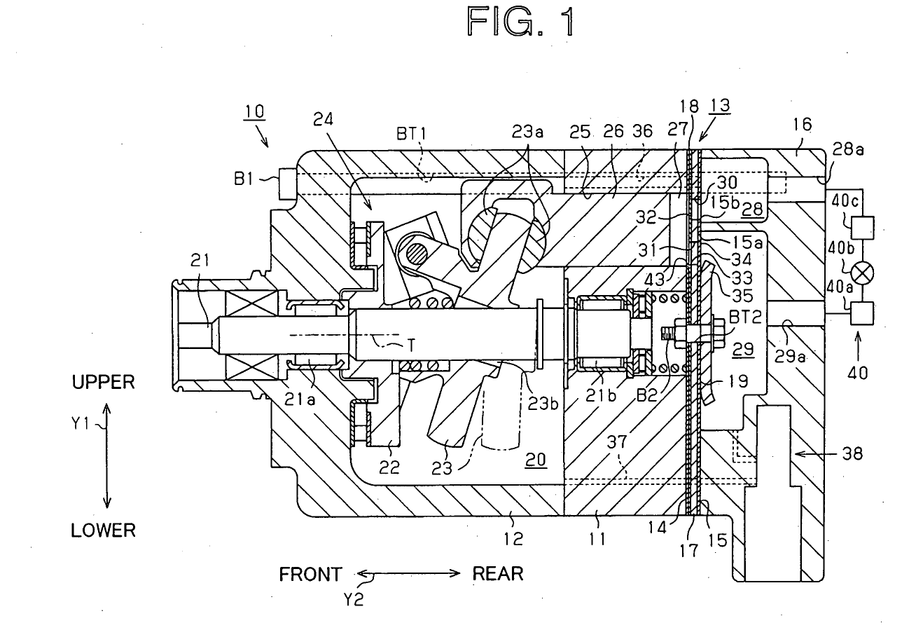

The following will describe a preferred embodiment according to the present invention with reference to FIGS. 1 through 4B, in which the present invention is applied to a single-headed piston, swash plate type variable displacement compressor for a vehicle air-conditioner which uses carbon dioxide as refrigerant. Note that the double-headed arrow Y1 in FIG. 1 indicates the upper and lower sides of a piston type compressor 10 and the double-headed arrow Y2 indicates the front and rear sides of the compressor 10.

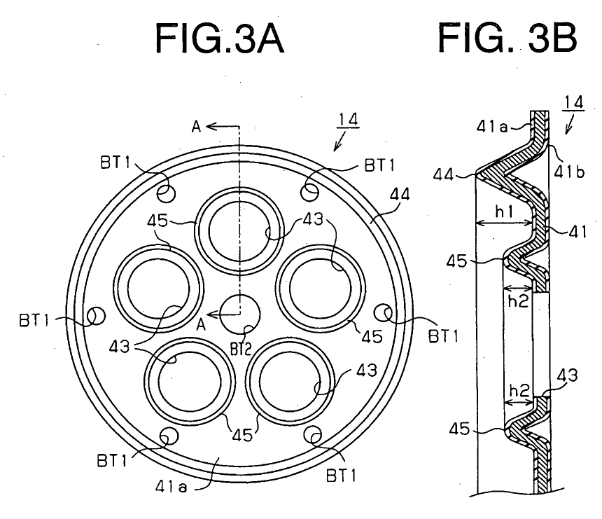

Referring to FIG. 1 showing a longitudinal cross-sectional view of the compressor 10, it includes three housing components, namely, a cylinder block 11, a front housing 12, and a rear housing 16. The front housing 12 is joined to the front end of the cylinder block 11, and the rear housing 16 is joined to the rear end of the cylinder block 11 through a valve-port assembly 13 and gaskets 14 and 15 as seal members. These housing components are cylindrical and have substantially the same outer diameters. The valve-port assembly 13 is disc-shaped and includes a valve plate 17 which has the same outer diameter as the housing components, a suction valve plate 18 which is joined to the front surface of the valve plate 17, and a discharge valve plate 19 which is joined to the rear surface of the valve plate 17. Six holes BT1 are formed (FIGS. 1 and 3) in the cylinder block 11, the front housing 12, the suction valve plate 18 and the valve plate 17 of the valve-port assembly 13, the gaskets 14 and 15, and the rear housing 16 for receiving therethrough six bolts B1 as a fastening member, respectively. Thus, the cylinder block 11, the front housing 12, the valve-port assembly 13, the gaskets 14 and 15, and the rear housing 16 are fastened together by the bolts B1. Only one hole BT1 and one bolt B1 are shown in FIG. 1. The holes BT1 are formed adjacent to the outer periphery of each member, and the bolts B1 for fixing the housing components together are located adjacent to the outer periphery of the compressor 10.

The cylinder block 11 and the front housing 12 cooperate to define therebetween a crank chamber 20, and a drive shaft 21 extends in the crank chamber 20. The drive shaft 21 is rotatably supported by the cylinder block 11 and the front housing 12 through radial bearings 21a and 21b, and connected to an engine as the drive source of a vehicle.

In the crank chamber 20, a disc-shaped lug plate 22 is secured on the drive shaft 21 for rotation therewith. A disc-shaped swash plate 23 as a cam plate is provided in the crank chamber 20. The swash plate 23 has a center hole 23b through which the drive shaft 21 is inserted so that the swash plate 23 is rotatably and inclinably supported by the drive shaft 21 through the hole 23b. A hinge mechanism 24 is interposed between the swash plate 23 and the lug plate 22, and the swash plate 23 is connected to the lug plate 22 through the hinge mechanism 24. Such arrangement permits the swash plate 23 to rotate synchronously with the lug plate 22 and the drive shaft 21 and to incline with respect to the drive shaft 21 while sliding in the direction of the axis T of the drive shaft 21.

The cylinder block 11 has formed therethrough a plurality of cylinder bores 25 (five cylinder bores in the preferred embodiment) which are arranged around the drive shaft 21 at equiangular intervals and extend in the direction of the axis T of the drive shaft 21. Each cylinder bore 25 receives therein a single-headed piston 26 for reciprocation. The front and rear openings of the cylinder bore 25 are closed by the piston 26 and the valve-port assembly 13, respectively, so that a compression chamber 27 is defined in the cylinder bore 25. The volume of the compression chamber 27 is variable in accordance with the reciprocation of the piston 26.

The working stroke of the piston 26 is determined by the differential pressure between the pressure acting on the rear surface of the piston 26 (or the surface facing the compression chamber 27 in FIG. 1), that is, the pressure in the compression chamber 27, and the pressure acting on the front surface of the piston 26 (or the surface facing the crank chamber 20 in FIG. 1), that is, the pressure in the crank chamber 20. As the differential pressure between the compression chamber 27 and the crank chamber 20 is increased, the inclination angle of the swash plate 23 is decreased thereby to decrease the stroke length of the piston 26. On the other hand, as the differential pressure between the compression chamber 27 and the crank chamber 20 is decreased, the inclination angle of the swash plate 23 is increased thereby to increase the stroke length of the piston 26.

Each piston 26 engages with the outer peripheral portion of the swash plate 23 through a pair of shoes 23a. As the swash plate 23 is rotated with the drive shaft 21, the swash plate 23 makes a wobbling motion in the direction of the axis T of the drive shaft 21, thereby causing the piston 26 to move reciprocally in its cylinder bore 25 in the direction of the axis T of the drive shaft 21. In the compressor 10 of the preferred embodiment, the crank chamber 20, the drive shaft 21, the swash plate 23, the piston 26, and the like constitute a compression mechanism.

A suction chamber 28 as a suction-pressure region and a discharge chamber 29 as a discharge-pressure region are defined in the rear housing 16. More specifically, the suction chamber 28 is provided radially outward of the discharge chamber 29 so as to surround the discharge chamber 29. The rear housing 16 has an inlet 28a through which refrigerant gas is introduced into the suction chamber 28. The rear housing 16 has an outlet 29a through which refrigerant gas in the discharge chamber 29 is delivered out of the compressor 10.

The valve plate 17 of the valve-port assembly 13 has suction ports 30 which are located in radially outward region of the valve plate 17 in facing relation to the respective cylinder bores 25. The valve plate 17 has discharge ports 31 which are located radially inward of the suction ports 30 in facing relation to the respective cylinder bores 25. The suction valve plate 18 of the valve-port assembly 13 has suction valves 32 for opening and closing the respective suction ports 32. The suction valve plate 18 has discharge holes 33 which are located at positions corresponding to the respective discharge ports 31. The discharge valve plate 19 has discharge valves 34 for opening and closing the respective discharge ports 31. The opening degree of the discharge valve 34 is restricted by a retainer 35. The gasket 14, the suction valve plate 18, the valve plate 17, the discharge valve plate 19, the gasket 15 and the retainer 35 are arranged between the cylinder block 11 and the rear housing 16 in this order as seen from the cylinder block 11 and these are fastened together by a bolt B2. A hole BT2 is formed in the gaskets 14 and 15, the suction valve plate 18, the valve plate 17, the discharge valve plate 19, and the retainer 35 for receiving therethrough the bolt B2. The suction valve plate 18 is fixed so that the suction valves 32 are located at positions corresponding to the respective suction ports 30, and the discharge valve plate 19 is fixed so that the discharge valves 34 are located at positions corresponding to the respective discharge ports 31.

The compressor 10 is provided with a bleed passage 36, a supply passage 37 and a known electromagnetically operated control valve 38. The bleed passage 36 connects the crank chamber 20 to the suction chamber 28, and the supply passage 37 connects the discharge chamber 29 to the crank chamber 20. The control valve 38 is arranged in the supply passage 37.

The compressor 10 is connected to an external refrigerant circuit 40. More specifically, the inlet 28a and the outlet 29a in the rear housing 16 are connected through the external refrigerant circuit 40. The external refrigerant circuit 40 includes a condenser 40a, an expansion valve 40b, and an evaporator 40c. The refrigerant gas is introduced from the evaporator 40c in the external refrigerant circuit 40 to the suction chamber 28 through the inlet 28a. During the suction stroke when the piston 26 moves from its top dead center toward its bottom dead center, the refrigerant gas in the suction chamber 28 is drawn into the compression chamber 27 through the suction port 30 while pushing open the suction valve 32. During the discharge stroke when the piston 26 moves from its bottom dead center toward its top dead center, the refrigerant gas in the compression chamber 27 is compressed to a predetermined pressure and then discharged into the discharge chamber 29 through the discharge port 31 while pushing open the discharge valve 34. The refrigerant gas in the discharge chamber 29 is delivered out of the compressor 10 to the external refrigerant circuit 40 through the outlet 29a of the discharge chamber 29. In the compressor 10 of the present preferred embodiment, a refrigerant passage is provided by the compression chamber 27, the suction chamber 28, the discharge chamber 29, the suction port 30, and the discharge chamber 31. It is noted that the refrigerant passage is provided for each of the compression chambers 27.

In operation of the compressor 10, the opening degree of the control valve 38 is adjusted to control the balance between the amount of the high-pressure refrigerant gas supplied to the crank chamber 20 through the supply passage 37 and the amount of the refrigerant gas drawn from the crank chamber 20 through the bleed passage 36. Thus, the pressure in the crank chamber 20 is adjusted and the inclination angle of the swash plate 23 is changed, accordingly, thereby variably controlling the stroke length of the piston 26 and hence the displacement of the compressor 10. As the opening degree of the control valve 38 is decreased, the pressure in the crank chamber 20 is decreased and the inclination angle of the swash plate 23 is increased thereby to increase the stroke length of the piston 26 and hence the displacement of the compressor 10. On the other hand, as the opening degree of the control valve 38 is increased, the pressure in the crank chamber 20 is increased and the inclination angle of the swash plate 23 is decreased thereby to decrease the stroke length of the piston 26 and hence the displacement of the compressor 10.

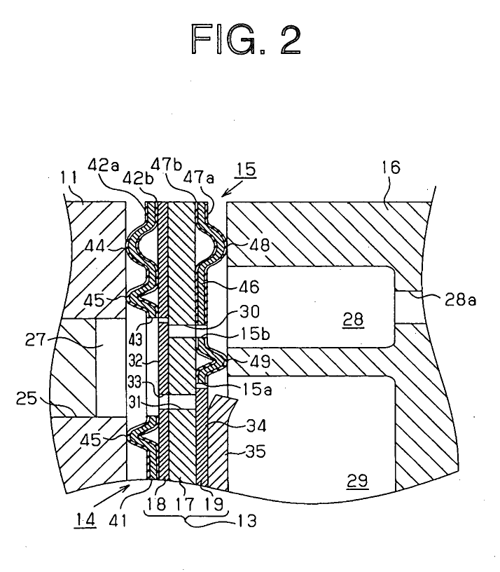

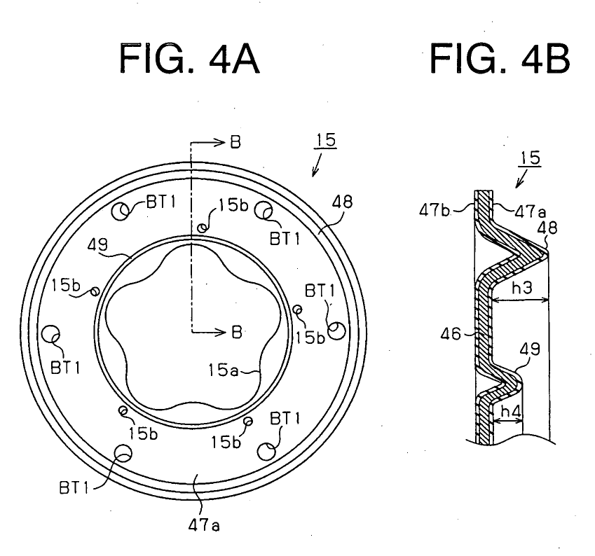

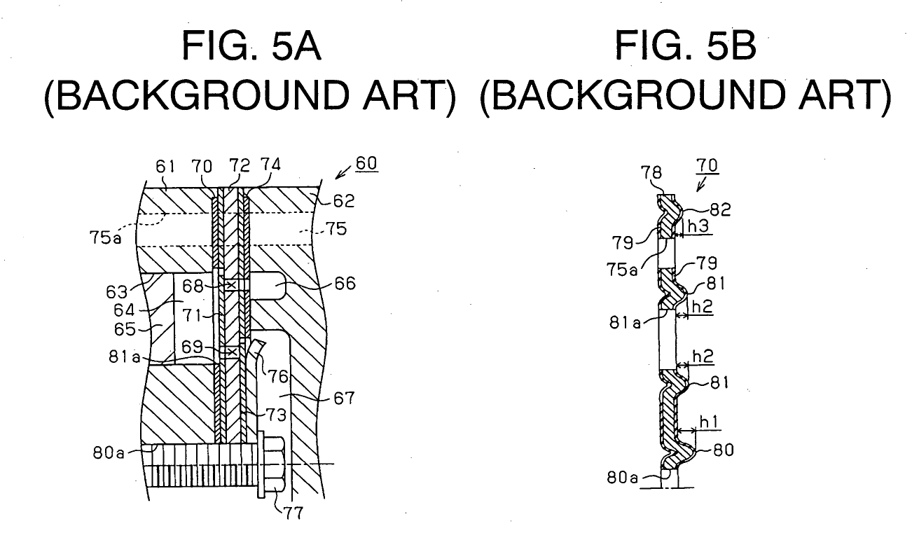

The following will describe in detail the structures of the gaskets 14 and 15 which are used in the compressor 10 of the preferred embodiment with reference to FIGS. 2 through 4B. FIG. 2 is a partially enlarged cross-sectional view of the compressor 10 of FIG. 1, showing part of the compressor 10 adjacent to the compression chamber 27, the suction chamber 28 and the discharge chamber 29. It is noted that FIG. 2 shows a state of the compressor 10 before the bolts B1 are fastened and that no gap is formed between the cylinder block 11 and the rear housing 16 after the bolts B1 are fastened. FIG. 3A is a front view of the gasket 14 interposed between the cylinder block 11 and the suction valve plate 18 as viewed from the side of the cylinder block 11, or toward the rear side of the compressor 10 in FIG. 1. FIG. 3B is a cross-sectional view that is taken along the line A-A in FIG. 3A. FIG. 4A is a front view of the gasket 15 interposed between the rear housing 16 and the valve plate 17 as viewed from the side of the rear housing 16, or toward the front side of the compressor 10 in FIG. 1. FIG. 4B is a cross-sectional view that is taken along the line B-B in FIG. 4A.

The following will describe the structure of the gasket 14 as a first seal member which is located adjacent to the cylinder block 11. The gasket 14 is disc-shaped as shown in FIG. 3A, including a metal plate 41 having rubber coatings 42a and 42b on both surfaces of the metal plate 41 as shown in FIG. 3B. The gasket 14 has substantially the same outer diameter as the housing components and the valve plate 17. The gasket 14 has at its center the hole BT2 for receiving therethrough the bolt B2 and around the hole BT2 a plurality of holes 43 (five holes in the preferred embodiment) which are formed at equiangularly spaced positions corresponding to the openings of the cylinder bores 24, that is, at positions corresponding to the compression chambers 27 in the cylinder bores 24. Thus, when the gasket 14 is set properly between the cylinder block 11 and the rear housing 16, the suction port 30 and the discharge hole 33 (the discharge port 31) are located at position corresponding to the respective hole 43 of the gasket 14. The gasket 14 has formed therethrough at positions between the outer periphery thereof and the holes 43 a plurality of the holes BT1 (six holes in the preferred embodiment) for receiving therethrough the bolts b1.

The gasket 14 has formed adjacent to the outer periphery thereof a projecting outer bead 44 as a first seal portion. As shown in FIG. 3A, the outer bead 44 which is formed continuously and annularly along the outer periphery of the gasket 14 has a circular shape as viewed from the front side. The gasket 14 has formed adjacent to the outer peripheries of the holes 43 projecting inner beads 45 as a second seal portion. The inner bead 45 is formed for each of the holes 43. As shown in FIG. 3A, each of the inner beads 45 which is formed continuously and annularly along the outer periphery of the respective hole 43 has a circular shape as viewed from the front side.

The outer and inner beads 44 and 45 are formed as full beads so as to project in the same direction, or toward the cylinder block 11 as shown in FIGS. 2 and 3B. When the gasket 14 is set properly between the cylinder block 11 and the rear housing 16, the outer bead 44 is located adjacent to the outer periphery of the compressor 10 and the inner beads 45 are located radially inward of the outer bead 44. Thus, the outer bead 44 functions to prevent the refrigerant gas from leaking out of the compressor 10, and the inner beads 45 function to prevent the refrigerant gas from leaking between any two adjacent compression chambers 27 (the adjacent refrigerant passages), that is, to seal the compression chambers 27.

The gasket 14 is provided with rubber coatings 42a, 42b on both surfaces of the metal plate 41 which is formed into a shape having the outer and inner beads 44 and 45. Thus, the gasket 14 has on its surfaces beaded portions (or beaded surface) forming the outer and inner beads 44 and 45 and non-beaded portions (or non-beaded surface) where no bead is formed. The non-beaded portions are planar.

The outer bead 44 is formed with a projection having a uniform height h1 (FIG. 3B) along its entire circumference. The height h1 of the outer bead 44 is a dimension as measured from the non-beaded portion of the gasket 14 to the top of the outer bead 44 as shown in FIG. 3B. More specifically, the height h1 of the outer bead 44 is the distance of a line extending from the top of the outer bead 44 to the non-beaded portion of the gasket 14 in the direction perpendicular to the non-beaded portion of the gasket 14. The intersection point of the line and the non-beaded portion of the gasket 14 is located on the surface of the rubber coating on the raised or beaded side of the gasket 14, or the surface of the rubber coating 42a. On the other hand, each inner bead 45 is formed with a projection having a uniform height h2 (FIG. 3B) along its entire circumference. The height h2 of each inner bead 45 is a dimension as measured from the non-beaded portion of the gasket 14 to the top of the inner bead 45 as shown in FIG. 3B. In the preferred embodiment, the outer and inner beads 44 and 45 are formed so as to satisfy the following relation:

h2<h1.

The following will describe the structure of the gasket 15 as a second seal member which is located adjacent to the rear housing 16. The gasket 15 which is disc-shaped as shown in FIG. 4A includes a metal plate 46 having rubber coatings 47a and 47b on both surfaces of the metal plate 46 as shown in FIG. 4B. The gasket 15 has substantially the same outer diameter as the housing components, the valve plate 17, and the gasket 14. The gasket 15 has at its center a hole 15a for receiving therein the discharge valve plate 19. Thus, when the gasket 15 is set properly between the cylinder block 11 and the rear housing 16, the discharge ports 31 are located in the hole 15a. The gasket 15 has formed therethrough at positions between the outer periphery thereof and the hole 15a a plurality of the holes BT1 (six holes in the preferred embodiment) for receiving therethrough the bolts B1. The gasket 15 has also formed therethrough between the hole 15a and the holes BT1 a plurality of holes 15b which are located at positions corresponding to the suction ports 30 of the valve plate 17, respectively, for the refrigerant gas to pass therethrough.

The gasket 15 has formed adjacent to the outer periphery thereof a projecting outer bead 48 as a first seal portion. As shown in FIG. 4A, the outer bead 48 which is formed continuously and annularly along the outer periphery of the gasket 15 has a circular shape as viewed from the front side. The outer bead 48 is formed at the position corresponding to the outer bead 44 of the gasket 14 when the gasket 15 is interposed between the cylinder block 11 and the rear housing 16 as shown in FIG. 2. The gasket 15 has formed adjacent to the outer periphery of the hole 15a a projecting inner bead 49 as a second seal portion. As shown in FIG. 4A, the inner bead 49 which is formed continuously and annularly along the outer periphery of the hole 15a has a circular shape as viewed from the front side.

The outer and inner beads 48 and 49 are formed as full beads so as to project in the same direction, or toward the rear housing 16 as shown in FIGS. 2 and 4B. When the gasket 15 is set properly between the cylinder block 11 and the rear housing 16, the outer bead 48 is located adjacent to the outer periphery of the compressor 10 and the inner bead 49 is located radially inward of the outer bead 48. Thus, the outer bead 48 functions to prevent the refrigerant gas from leaking out of the compressor 10, and the inner bead 49 functions to prevent the refrigerant gas form leaking between the suction chamber 28 and the discharge chamber 29 (the adjacent refrigerant passages), that is, to seal the suction chamber 28 and the discharge chamber 29.

The gasket 15 is provided with rubber coatings 47a and 47b on both surfaces of the metal plate 46 which is formed into a shape having the outer and inner beads 48 and 49. Thus, the gasket 15 has on its surfaces beaded portions (or beaded surface) forming the outer and inner beads 48 and 49 and non-beaded portions (or non-beaded surface) where no bead is formed. The non-beaded portions are planar.

The outer bead 48 is formed with a projection having a uniform height h3 along the entire outer periphery of the gasket 15. The height h3 of the outer bead 48 is a dimension as measured from the non-beaded portion of the gasket 15 to the top of the outer bead 48 as shown in FIG. 4B. More specifically, the height h3 of the outer bead 48, which is determined in the same manner as the height h3 of the outer bead 44, is substantially the same as the height h1 in the preferred embodiment. The inner bead 49 is formed with a projection having a uniform height h4 along the entire outer periphery of the hole 15a. The height h4 of the inner bead 49, which is determined in the same manner as the height h2 of the inner beads 45, is substantially the same as the height h2 in the preferred embodiment. In the preferred embodiment, the outer and inner beads 48 and 49 are formed so as to satisfy the following relation:

h4<h3.

The above-described gasket 14 is disposed between the cylinder block 11 and the valve-port assembly 13 so that the outer and inner beads 44 and 45 are in contact with the rear surface of the cylinder block 11 as shown in FIG. 2. The gasket 15 is disposed between the valve-port assembly 13 and the rear housing 16 so that the outer and inner beads 48 and 49 are in contact with the front surface of the rear housing 16, as shown in FIG. 2. With the gaskets 14 and 15 thus arranged, the bolts B1 are fastened to fix together the cylinder block 11, the gaskets 14, 15, the valve-port assembly, and the rear housing 16. The beads 44 and 45 of the gasket 14 and the beads 48 and 49 of the gasket 49 are pressed against the rear surface of the cylinder block 11 and the front surface of the rear housing 16, respectively, under a contact pressure according to the fastening force (axial force) of the bolts B1.

Since the shapes, more specifically, the heights h1 and h2 of the outer and inner beads 44 and 45 of the gasket 14 are different from each other, the contact pressures of the outer and inner beads 44 and 45 are different from each other. Since the height h1 of the outer bead 44 is larger than the height h2 of the inner beads 45, the contact pressure of the outer bead 44 is larger than that of the inner beads 45. Similarly, since the shapes, more specifically, the heights h3 and h4 of the outer and inner beads 48 and 49 of the gasket 15 are different from each other, the contact pressures of the outer and inner beads 48 and 49 are different from each other. Since the height h3 of the outer bead 48 is larger than the height h4 of the inner bead 49, the contact pressure of the outer bead 48 is larger than that of the inner bead 49.

The seal structure of the compressor 10 of the preferred embodiment is provided in such a way that the contact pressures of the gaskets 14 and 15 increase toward the radially outer side of the compressor. Further, the bolts B1 of the compressor 10 are located adjacent to the outer periphery of each housing component. Thus, in the seal structure of the preferred embodiment, the beads adjacent to the bolts B1 (or the outer beads 44 and 48) have larger height and hence greater contact pressure. Each of the heights h1 through h4 of the beads 44, 45, 48 and 49 is set so as to produce a contact pressure that is required for preventing leak of the refrigerant gas. The contact pressure to be produced depends on the fastening force of the bolts B1 and the kind of refrigerant to be used. When carbon dioxide is used as refrigerant in the compressor 10 of the preferred embodiment, the required contact pressure is larger than that in case of using chlorofluorocarbon as refrigerant.

The following will describe the operation of the compressor 10 of the preferred embodiment. In the compressor 10, the refrigerant gas in the suction chamber 28 is drawn into the compression chamber 27, compressed in the compression chamber 28 and discharged into the discharge chamber 29, as described earlier herein. Thus, the pressures in the compression chamber 27, the suction chamber 28 and the discharge chamber 29 vary during suction and discharge strokes, thereby generating pressure differential among the compression chamber 27, the suction chamber 28 and the discharge chamber 29. For example, during the suction stroke, there is no pressure differential between the compression chamber 27 and the suction chamber 28 but a pressure differential is generated between the compression chamber 27 and the discharge chamber 29. On the other hand, during the discharge stroke, there is no pressure differential between the compression camber 27 and the discharge chamber 29 but the pressure differential is generated between the compression chamber 27 and the suction chamber 28.

The valve plate 17 is bent under the influence of the above pressure variation, thus the contact pressures of the gaskets 14 and 15 being changed, accordingly. More specifically, during the suction stroke, the gaskets 14 and 15 receive a force which presses the gaskets 14 and 15 against the cylinder block 11 and, during the discharge stroke, the gaskets 14 and 15 are subjected to a force which presses the gaskets 14 and 15 against the rear housing 16. The contact pressure of the gaskets 14 and 15 varies significantly specifically at the beads which are located adjacent to the refrigerant passage which are more susceptible to the influence of the pressure of the refrigerant gas drawn or discharged during the suction or discharge stroke (or the inner beads 45 and 49 in the preferred embodiment).

In the compressor 10 of the preferred embodiment, the heights h1 and h3 of the outer beads 44 and 48 are set larger than the heights h2 and h4 of the inner beads 45 and 49. That is, the heights of the beads located adjacent to the refrigerant passage are lower. Therefore, the degree of change in shape of the beads 45 and 49 when they undergo repeatedly alternate deformation by being pressed against contact surface by variable pressure and the subsequent restoration to their original shape is reduced. As a result, the gaskets 14 and 15 are less susceptible to damage due to pressure variation during the suction and discharge strokes which causes the repeated deformation and restoration of the gaskets 14 and 15.

It is noted that since leakage of the refrigerant gas from the refrigerant passage is permissible within the range in which the compressor 10 can maintain its intended performance, priority may be attached to successful prevention of damage to the inner beads 45 and 49 in setting the heights h2 and h4 of the inner beads 45 and 49 which are more susceptible to the pressure variation. Meanwhile, since the airtightness of the compressor 10 need to be ensured for preventing the refrigerant gas from leaking out of the compressor 10, priority may be attached to the airtightness of the compressor 10 in setting the heights h1 and h3 of the outer beads 44 and 48.

According to the preferred embodiment described above, the following advantageous effects are obtained.

(1) The heights h2 and h4 of the inner beads 45 and 49 adjacent to the refrigerant passage are set smaller than the heights h1 and h3 of the outer beads 44 and 48 which are located more distant from the refrigerant passage than the inner beads 45 and 49, so that the degree of deformation and restoration of the beads 45 and 49 which is caused by variation of the contact pressure of the beads due to the pressure variation in the compressor 10 is reduced, with the result that the degree of deformation of the beads 45 and 49 is reduced and, therefore, the gaskets 45 and 45 are successfully prevented from being damaged.

(2) The heights h1 and h3 of the beads 44 and 48 may be set at a level which produces a contact pressures thereof that is enough to ensure the airtightness of the compressor 10.

(3) The outer beads 44 and 48 are located at positions adjacent to the fastening bolts B1 where the beads 44 and 48 are less susceptible to the influence of pressure variation in the compressor 10 and, therefore, the beads 44 and 48 are pressed against the contact surfaces of the cylinder block 11 and the rear housing 16 with a contact pressures by the fastening force of the bolts B1 that is enough to ensure the airtightness of the compressor 10.

(4) When carbon dioxide is used as refrigerant, the working pressure in the compressor 10 is much higher than that in the case of using chlorofluorocarbon as refrigerant and the pressure differential between high-pressure region and low-pressure region in the compressor 10 is large, thus making the refrigerant gas easy to leak. Thus, when carbon dioxide is used as refrigerant, the gaskets 14 and 15 are required to provide higher airtightness of the compressor 10 than the case of using chlorofluorocarbon as refrigerant. In the refrigeration cycle using carbon dioxide as refrigerant in the preferred embodiment, the outer beads 44 and 48 maintains the airtightness of the compressor 10 while the inner beads 45 and 49 is prevented from being damages by varying contact pressures due to the pressure variation within the compressor 10.

The above preferred embodiment may be modified in various ways as exemplified below.

In an alternative embodiment, the beads 44, 45, 48 and 49 may be formed as half beads. In any one of the gaskets 14 and 15, either of the outer and inner beads may be formed as a full bead, while the other may be formed as a half bead.

In an alternative embodiment, each of the gaskets 14 and 15 may be provided by a flat metal plate which is clad on both surfaces with rubber coatings having raised portions serving as beads.

In an alternative embodiment, the present invention may be applied to a double-headed piston type compressor instead of the single-headed piston type compressor as shown in FIG. 1.

In an alternative embodiment, the compressor 10 may be used in a refrigeration cycle of a vehicle air-conditioner in which refrigerant such as chlorofluorocarbon other than carbon dioxide is used.

In the preferred embodiment, the compressor 10 is of a five-cylinder type. However, the compressor may have cylinder bores the number of which is other than five.

The inner beads 45 and 49 of the gaskets 14 and 15 are formed with the heights h2 and h4 which are of substantially the same dimension in the above-described preferred embodiment. In an alternative embodiment, however, the inner beads 45 and 49 may be formed with heights which are different from each other. In this case, it is preferable that the inner beads for the gasket 14 should be lower than that for the gasket 15. In the compressor 10 of the preferred embodiment, the length of the beads of the gasket 14 adjacent to the cylinder block 11 is longer than that of the gasket 15, so that contact pressure of the gasket 14 is dispersed relatively easily. Thus, the contact pressure of one of the inner beads 45 of the gasket 14 is smaller than that of the inner bead 49 of the gasket 15 and, therefore, the inner beads 45 of the gasket 14 are more susceptible to the pressure variation in the compressor. For that reason, the beads 45 are formed with a height that is smaller than that of the bead 49.

In an alternative embodiment, the bolts for fastening the housing member of the compressor such as bolts B1 may be disposed adjacent to the center of the compressor.

In an alternative embodiment, the positions of the suction chamber 28 and the discharge chamber 29 in the rear housing 16 may be reversed. In other words, the discharge chamber 29 may be formed so as to surround the suction chamber 28.

Therefore, the present examples and embodiments are to be considered as illustrative and not restrictive, and the invention is not to be limited to the details given herein but may be modified within the scope of the appended claims.

What is claimed is:

1. A piston type compressor comprising:
a cylinder block having a plurality of cylinder bores;
a plurality of pistons disposed in the respective cylinder bores for defining compression chambers in the respective cylinder bores;
a housing for defining a suction-pressure region and a discharge-pressure region therein;
a valve-port assembly provided between the cylinder block and the housing, the valve-port assembly having suction ports which connect the suction-pressure region to the respective compression chambers and discharge ports which connect the respective compression chambers to the discharge-pressure region, thereby refrigerant passages being provided by the respective compression chambers, the suction-pressure region, the discharge-pressure region, the respective suction ports, and the respective discharge ports, wherein refrigerant is drawn from the suction-pressure region into the compression chambers through the respective suction ports and discharged from the compression chambers into the discharge-pressure region through the respective discharge ports after compression; and
a seal member provided between the cylinder block and the housing, wherein the valve-port assembly and the seal member are fastened together by a fastening member,
wherein the seal member has a first seal portion for preventing the refrigerant from leaking out of the compressor and a second seal portion for preventing the refrigerant from leaking between the adjacent refrigerant passages, each of the first and second seal portions has a bead, and the bead of the second seal portion has a height which is smaller than that of the first seal portion.

2. The piston type compressor according to claim 1, wherein the first seal portion is located along each of outer peripheries of end surfaces of the cylinder block and the housing, the second seal portion is located radially inward of the first seal portion, and the cylinder block, the seal member, and the housing are fastened together by the fastening member which is located adjacent to the outer peripheries of the end surfaces of the cylinder block and the housing.

3. The piston type compressor according to claim 2, wherein the seal member includes a first seal member which is provided between the cylinder block and the valve-port assembly and a second seal member which is provided between the housing and the valve-port assembly, each of the first and second seal members has the first and second seal portions, the second seal portion of the first seal member is located so as to surround each of openings of the cylinder bores for preventing the refrigerant from leaking out of each of the compression chambers, and the second seal portion of the second seal member is located between the suction-pressure region and the discharge-pressure region for preventing the refrigerant from leaking between the suction-pressure region and the discharge-pressure region.

4. The piston type compressor according to claim 3, wherein the height of the bead of the second seal portion of the first seal member is substantially the same as or smaller than that of the second seal portion of the second seal member.

5. The piston type compressor according to claim 3, wherein the beads of the first and second seal portions of the first seal member are formed so as to project toward the cylinder block.

6. The piston type compressor according to claim 3, wherein the beads of the first and second seal portions of the second seal member are formed so as to project toward the housing.

7. The piston type compressor according to claim 3, wherein each of the first and second seal members includes a metal plate having rubber coatings on both surfaces of the metal plate.

8. The piston type compressor according to claim 3, wherein the first seal portion of the first seal member is adjacent to the first seal portion of the second seal member.

9. The piston type compressor according to claim 1, wherein the compressor is used in a refrigeration cycle in which carbon dioxide is used as the refrigerant.
